(19) United States
(12) Patent Application Publication
(10) Pub. No.: US 2008/0187733 A1
(43) Pub. Date: Aug. 7, 2008

(54) Wipes

(75) Inventors: Oday Abbosh, London (GB); Ian Hamilton Dryburgh, Hampshire (GB); Nigel Lawson, Kent (GB); Timothy Michael Wood, Herts (GB); David Richard Stonehouse, Cambridge (GB)

Correspondence Address: KAMRATH & ASSOCIATES P.A., 4825 OLSON MEMORIAL HIGHWAY, SUITE 245, GOLDEN VALLEY, MN, 55422, US

(73) Assignee: Oday Abbosh, London (GB)

(21) Appl. No.: 11/813,587

(22) PCT Filed: Dec. 20, 2005
(86) PCT No.: PCT/GB2005/004961

§ 371 Date: Oct. 18, 2007

(30) Foreign Application Priority Data
Jan. 10, 2005 (GB) 0500404.9

(51) Int. Cl. B32B 29/02

(52) U.S. Cl. 428/218

(57) ABSTRACT

A wipe in the form of an absorbent tissue which comprises at least two layers of material, one of which is non-porous or at least sufficiently less porous than the other so that it forms a hygienic barrier.

This invention relates to wipes and in particular, though not exclusively, to hygienic wipes such as lavatory paper.

According to the invention there is provided a wipe in the form of an absorbent tissue which comprises at least two layers of material, one of which is non-porous or at least sufficiently less porous than the other so that it forms a hygienic barrier.

Lavatory paper is customarily used as folded or scrunched sheets of tissue, either torn from a perforated roll or drawn from a stack of individual sheets. With the softer kinds of conventional tissue, there is a concern about soiling of the user's hands caused by the tissue breaking through. This can lead to use of excessive sheets of tissue. Breaking through is less of a problem with the harder kinds of conventional tissue, but these are harsher in use and thus not preferred. The present invention enables a wipe to be produced which has the dual benefits of the softness associated with conventional softer tissues, with the resistance to breaking through associated with conventional harder tissues.

In its simplest form, a wipe according to the invention could consist of a layer of soft tissue, like the material of a conventional soft lavatory paper, backed by a layer of harder tissue, like the material of a conventional hard lavatory paper. Alternatively, two layers of soft tissue could be provided, with a layer of harder tissue sandwiched in between. In either case, the harder tissue layer would act as a hygienic barrier, preventing breaking through and soiling of the user's hands. Further alternative arrangements are of course possible with multiple layers.

Advantageously, a wipe according to the invention could be provided for use as a single individual item, which need not be folded or scrunched. Ideally, such a wipe would be specially shaped for this purpose. If the wipe were to be of a more elongate form, for example, this would allow enough material for the wipe to be grasped by a user's hand spaced apart from the area of the wipe to be soiled. Also, if the area of the wipe to be soiled were to be something less than rectangular in shape, this would help reduce the amount of material needed to a minimum. With a conventional rectangular shape, the corner portions of a wipe are not usually used, and so simply go to waste as excess material. A wipe of generally oval or pear-shaped section, for example, would have the benefits described above.

The layer or layers of softer material in the wipe could be provided in a single ply or, more likely, in two or more plies. With a single-use wipe of oval shape, it has been found that it would be possible to provide multiple plies of soft tissue and yet still use less weight of material than is typically used with conventional tissue papers. This allows for more efficient use of material and reduces the likelihood of blockages occurring in sanitation waste systems.

The barrier material in the wipe could be provided as a single or plural ply layer. The wipe may be provided with an antibacteriological agent, possibly as part of the barrier layer. Also, it may be impregnated, for example with a scent. Further, the wipe may be given a surface decoration or otherwise treated, such as by printing, perforating, embossing or quilting.

Wipes made in accordance with the invention may be useful in many other applications, such as for example in the medical field. Such wipes may comprise an antiseptic or disinfectant, as a separate agent and/or possibly as part of the hygienic barrier.

The wipes described herein could be produced by any conventionally known manner, such as by being cut from a web of material made in a continuous process on a machine.

Dispensers for storing a stock of the wipes could be designed to match their shape and allow them to be drawn off one by one.

1. A wipe in the form of an absorbent tissue which comprises at least two layers of material, one of which is non-porous or at least sufficiently less porous than the other so that it forms a hygienic barrier.

2. A wipe as claimed in claim 1 in which the wipe is of a non-rectangular shape.

3. A wipe as claimed in claim 2 wherein the wipe is of a generally circular or oval shape.

4. A wipe as claimed in claim 3 wherein the wipe has an elongate form, eg pear-shaped.

5. A wipe as claimed in claim 1 wherein the wipe is of a generally circular or oval shape.

6. A wipe as claimed in claim 5 wherein the wipe has an elongate form, eg pear-shaped.

7. A wipe as claimed in claim 1 wherein the wipe has an elongate form, eg pear-shaped.

8. A wipe as claimed in claim 2 wherein the wipe has an elongate form, eg pear-shaped.
